(19) United States
(12) Patent Application Publication
(10) Pub. No.: US 2025/0153381 A1
(43) Pub. Date: May 15, 2025

(54) RAZOR BLADE

(71) Applicant: DORCO CO., LTD., Yongin-si (KR)

(72) Inventors: Hyun Kyu JUNG, Seoul (KR); Min Joo PARK, Seoul (KR); Seong Won JEONG, Seoul (KR); Myoung Jin KIM, Seoul (KR)

(21) Appl. No.: 18/947,745

(22) Filed: Nov. 14, 2024

(30) Foreign Application Priority Data
Nov. 15, 2023 (KR) 10-2023-0157941
Nov. 13, 2024 (KR) 10-2024-0161276

(51) Int. Cl. B26B 21/56; B26B 21/60

(52) U.S. Cl. CPC B26B 21/56; B26B 21/60

(57) ABSTRACT

A razor blade is proposed. The razor blade may include a substrate and a coating layer laminated on the substrate and having a coating tip formed on an end portion. The coating layer may include a pair of coating facets extending from the coating tip. The pair of coating facets may include a pair of first coating facets each having one end forming the coating tip and a pair of second coating facets each connected to the other end of each of the pair of first coating facets. A vertical distance between a straight line connecting the pair of wedge points and the coating tip may range from 0.5 micrometers to 1.5 micrometers.

### CROSS REFERENCE TO RELATED APPLICATIONS

This application claims priority from Korea Patent Application No. 10-2023-0157941, filed on Nov. 15, 2023, and Korea Patent Application No. 10-2024-0161276, filed on Nov. 13, 2024, which are hereby incorporated by reference for all purposes as if fully set forth herein. This application relates to U.S. Patent Application (Attorney Docket: VER1001.036AUS), entitled “RAZOR BLADE” and concurrently filed with this application, which is incorporated herein by reference in its entirety.

### BACKGROUND

### Technical Field

The present disclosure relates to a razor blade.

### Description of Related Technology

The shape of a razor blade plays an important role in the quality of shaving. In particular, the shape of a cutting edge included in the razor blade greatly affects both the cutting force and durability of the razor blade. Here, the cutting force refers to a force required for the razor blade to cut a single hair.

### SUMMARY

One aspect is a razor blade that ensures durability and offers a comfortable shaving experience through the shape of a coating layer in a tip region.

Another aspect is a razor blade comprising: a substrate; and a coating layer laminated on the substrate and having a coating tip formed on an end portion, wherein: the coating layer comprises a pair of coating facets extending from the coating tip, the pair of coating facets comprise: a pair of first coating facets each having one end forming the coating tip; and a pair of second coating facets each connected to the other end of each of the pair of first coating facets, when a pair of points where the pair of first coating lines extending in directions parallel to linearly extending regions of the pair of first coating facets and the pair of second coating lines extending in directions parallel to linearly extending regions of the pair of second coating facets intersect with each other are referred to as a pair of virtual points, and a pair of points where a plurality of straight lines perpendicular to the pair of first coating lines from the pair of virtual points intersect with the pair of coating facets are referred to as a pair of wedge points, a vertical distance between a straight line connecting the pair of wedge points and the coating tip ranges from 0.5 to 1.5 micrometers.

As described above, this embodiment has the effect of providing a razor blade that ensures durability and offers a comfortable shaving experience through the shape of a coating layer in a tip region.

### BRIEF DESCRIPTION OF THE DRAWINGS

FIG. 1 illustrates a razor blade according to an embodiment of the present disclosure in a schematic profile and a partially enlarged view.

FIG. 2 is a schematic view comparing a razor blade according to the prior art and a razor blade according to an embodiment of the present disclosure.

FIGS. 3A and 3B illustrate a contact relationship between the razor blade and skin when using the razor blade according to the prior art and the razor blade according to an embodiment of the present disclosure in FIG. 2, respectively.

FIG. 4 is a detailed view showing a coating layer of a razor blade according to an embodiment of the present disclosure.

### DETAILED DESCRIPTION

When the shape of a razor blade is sharp, its cutting force may be decreases, which may improve shaving experience. Recently, attempts have been made to make a substrate of the razor blade thinner to improve the shaving experience. However, when the substrate is made thinner, the durability of the razor blade is decreases, so a coating layer is essential to compensate for the reduced durability.

The most common way to enhance the durability through a coating layer is to increase the thickness of the coating layer. However, in this case, the thickness of the entire razor blade also increases, which may increase the cutting force. Therefore, in order to satisfy two conflicting requirements of increased durability and reduced cutting force, the shape of the coating layer needs to be additionally considered.

Hereinafter, some embodiments of the present disclosure will be described in detail with reference to the accompanying drawings. It is to be noted that in giving reference numerals to components of each of the accompanying drawings, the same components will be denoted by the same reference numerals even though they are illustrated in different drawings. Further, in describing exemplary embodiments of the present invention, well-known functions or constructions will not be described in detail since they may unnecessarily obscure the understanding of the present invention.

Terms ‘first’, ‘second’, i), ii), a), b), and the like, will be used in describing components according to embodiments of the present disclosure. These terms are only for distinguishing the components from other components, and the nature, sequence, order, or the like of the components are not limited by the terms. Throughout the present specification, unless explicitly described to the contrary, “including” or “comprising” any components will be understood to imply the inclusion of other elements rather than the exclusion of any other elements.

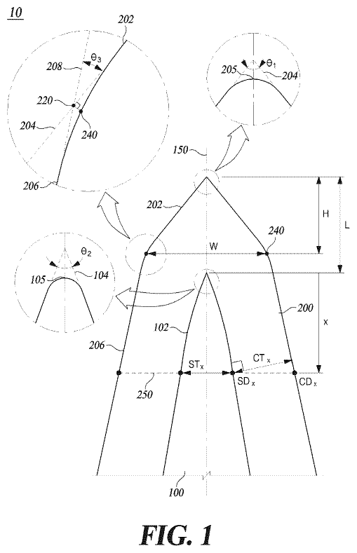

FIG. 1 illustrates a razor blade 10 according to an embodiment of the present disclosure in a schematic profile and a partially enlarged view.

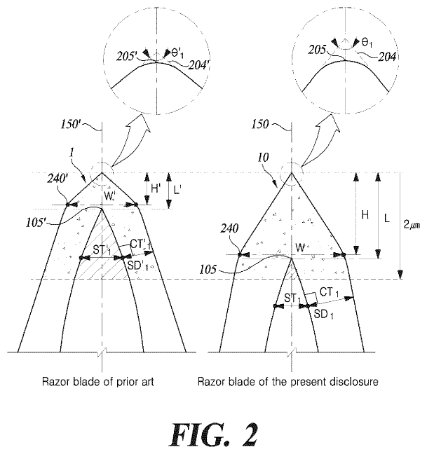

FIG. 2 is a schematic view comparing a razor blade 1 according to the prior art and the razor blade 10 according to an embodiment of the present disclosure.

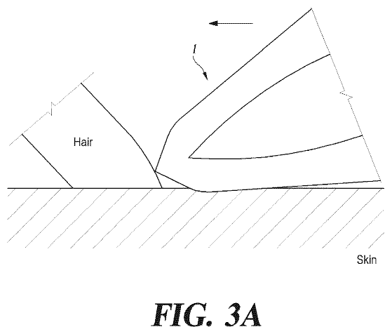

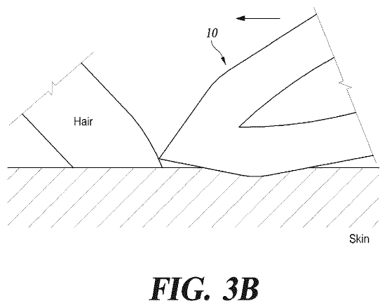

FIGS. 3A and 3B illustrate a contact relationship between the razor blade and skin when using the razor blade 1 according to the prior art and the razor blade 10 according to an embodiment of the present disclosure in FIG. 2, respectively.

Referring to FIG. 1, the razor blade 10 according to an embodiment of the present disclosure may include a substrate 100 and a coating layer 200.

The substrate 100 has a substrate tip 105 formed on an end portion. The substrate 100 may include any one of stainless steel, carbon steel, and ceramic. However, the present disclosure is not limited thereto.

The coating layer 200 is laminated on the substrate 100 and a coating tip 205 is formed on an end portion. The coating layer 200 may include a hard coating layer, an adhesive layer, and a polytetrafluoroethylene (PTFE) layer. The hard coating layer may include at least one of CrₓC_{y}B_{z} (x, y, and z are natural numbers equal to or greater than 1), CrₘBₙ (m and n are natural numbers equal to or greater than 1), CrC, and DLC (Diamond-Like Carbon). This will be described below in detail.

Meanwhile, the figures, shapes, etc. for the coating layer 200, which will be described below, are for the coating layer 200 excluding the PTFE layer. For instance, the thickness of the coating layer 200 described below refers to a thickness excluding the thickness of the PTFE layer. A pair of first coating facets 202, a pair of second coating facets 206, and a pair of third coating facets (not shown) described below also mean facets for the coating layer 200 excluding the PTFE layer. Although the PTFE layer may have the thickness of 500 nanometers or less, the present disclosure is not limited thereto.

The substrate 100 may include a pair of substrate facets 102 extending from the substrate tip 105. When a line passing through the coating tip 205 and the substrate tip 105 is referred to as a reference line 150, the pair of substrate facets 102 may extend substantially symmetrically with respect to the reference line 150.

The coating layer 200 may include a pair of coating facets 202 and 206 extending from the coating tip 205, and each of the pair of coating facets 202 and 206 may include a first coating facet 202 having one end that forms the coating tip 205 and a second coating facet 206 having one end that is connected to the other end of the first coating facet 202. Each of the first coating facet 202 and the second coating facet 206 is configured as a pair.

The extension directions of the pair of first coating facets 202 and the extension directions of the pair of second coating facets 206 may be different from each other. The pair of first coating facets 202 may extend substantially symmetrically with respect to the reference line 150. Further, the pair of second coating facets 206 may extend substantially symmetrically with respect to the reference line 150.

In the present disclosure, it is assumed that there are the pair of first coating facets 202 and the pair of second coating facets 206, that is, the pairs of coating facets 202 and 206 including two coating facets 202 and 206 on one side of the reference line 150. However, the present disclosure may further include a pair of third coating facets or more coating facets, one end of each coating facet being connected to the other end of each of the pair of second coating facets 206.

Hereinafter, lines extending in directions parallel to regions along which the pair of first coating facets 202 extend linearly are referred to as a pair of first coating lines 204, while lines extending in directions parallel to regions along which the pair of second coating facets 206 extend linearly are referred to as a pair of second coating line 208. Here, the first coating line 204 and the second coating line 208 are defined based on the coating layer 200 excluding the PTFE layer.

Meanwhile, a point where a horizontal line 250 that is perpendicular to the reference line 150 and passes through a point x micrometers away from the substrate tip 105 along the reference line 150 intersects with any one of the pair of substrate facets 102 is defined as SDx, and a point where the horizontal line 250 intersects with any one of the pair of coating facets 202 and 204 is defined as CDx.

Further, the thickness of the coating layer 200 at the point SDx is defined as a thickness CTx measured in a direction perpendicular to a straight line tangent to the substrate 100 at the point SDx.

Referring to FIG. 2, the razor blade 10 according to an embodiment of the present disclosure may have a value of 1.5 to 3, which is a distance L between the substrate tip 105 and the coating tip 205 divided by a thickness CT₁ of the coating layer 200 at a point SD₁.

Since a difference in the value of CT₁ is not large between razor blades, it can be seen that the razor blade 10 according to an embodiment of the present disclosure has a relatively larger distance L between the coating tip 205 and the substrate tip 105 compared to the razor blade 1 according to the prior art.

Since the deterioration of the durability of the razor blade 10, such as breakage, bending, and rust formation, occurs mainly near the substrate tip 105, protection of the substrate tip 105 is a major consideration in the manufacture of the razor blade 10. Since the distance L between the coating tip 205 and the substrate tip 105 of the razor blade 10 according to an embodiment of the present disclosure is greater than that of the razor blade 1 according to the prior art, the substrate tip 105 may be protected more effectively, thereby further enhancing the durability of the razor blade 10.

The distance L between the substrate tip 105 and the coating tip 205 may be from 0.15 to 1.2 micrometers, and the thickness CT₁ of the coating layer 200 at the point SD₁ may be from 50 to 500 nanometers. This may relatively increase the area ratio of the coating layer 200 in the tip region, and may further secure the durability of the razor blade 10. When a region overlapping the razor blade 10 among regions that are spaced 2 micrometers or less from a straight line passing through the coating tip 205 and parallel to the horizontal line 250 is referred to as a tip region, it can be seen that the razor blade 10 according to an embodiment of the present disclosure has a larger area ratio of the coating layer 200 to the substrate 100 in the tip region compared to the razor blade 1 according to the prior art. For instance, referring to FIGS. 1 and 2, the area ratio of the coating layer 200 to a total area of the razor blade 10 in the tip region may be from 65% to 85%.

Further, when cutting hair, the tip region of the razor blade 10 is most damaged due to factors such as the thickness of the hair. In particular, it has been confirmed through various studies that a defect in the razor blade 10 occurs around a point approximately 2 micrometers away from the coating tip 205. Therefore, the shape of the coating layer 200 in the tip region is very important for the durability of the razor blade.

Since the razor blade 10 according to an embodiment of the present disclosure has a larger area ratio of the coating layer 200 to the substrate 100 in the tip region compared to the razor blade 1 according to the prior art, the substrate tip 105 may be more effectively protected, thereby further securing the durability of the razor blade 10.

Damage to the tip region of the razor blade 10 impairs hair cutting performance and irritates the skin. Thus, in order to prevent the damage to the tip region of the razor blade 10, it is beneficial to increase the area of the coating layer 200 in the tip region as in the present disclosure.

Meanwhile, referring to FIGS. 1 and 2, a pair of points where the pair of first coating lines 204 and the pair of second coating lines 208 intersect with each other are referred to as a pair of virtual points 220, and a pair of points where straight lines perpendicular to the pair of first coating lines 204 from the pair of virtual points 220 intersect with the pair of coating facets 202 and 206 are referred to as a pair of wedge point 240.

The vertical distance H between the straight line connecting the pair of wedge points 240 and the coating tip 205 may be from 0.5 to 1.5 micrometers, for example, from 0.7 to 1.2 micrometers.

Referring further to FIGS. 3A and 3B in addition to FIGS. 1 and 2, it can be seen that a vertical distance H between a straight line connecting the pair of wedge points 240 and the coating tip 205 of the razor blade 10 according to an embodiment of the present disclosure is larger than that of the razor blade 1 according to the prior art.

Since the vertical distance H between a straight line connecting the pair of wedge points 240 and the coating tip 205 of the razor blade 10 according to an embodiment of the present disclosure is larger than that of the razor blade 1 according to the prior art, the area of the first coating facet 202 contacting the skin may be larger, thereby minimizing skin irritation.

The total cross-sectional area of the razor blade 10 between the straight line connecting the pair of wedge points 240 and the coating tip 205 may be from 0.2 μm² to 0.5 μm², for example, from 0.2 μm² to 0.3 μm². The proportion of the substrate 100 in the total cross-sectional area may be 15% or less, for example, 5% or less. For example, if the substrate 100 occupies 0% of an entire cross-section, the substrate 100 may not be present in the total cross-sectional area. The proportion of the coating layer 200 in the total cross-sectional area may be 85% or more, for example, 95% or more.

The total cross-sectional area of the razor blade 10 between the straight line connecting the pair of wedge points 240 and the coating tip 205 is a factor that affects skin contact as well as the initial cutting of the hair. If the cross-sectional area is too large, the razor blade 10 may become thicker, increasing the cutting force. If the cross-sectional area is too small, a sufficient wedge may not be formed, which may result in more skin irritation. For example, if the sufficient wedge is not formed, such as in the razor blade 1 according to the prior art of FIG. 3, the skin contact area may become smaller, and the skin irritation may become stronger during shaving. The razor blade 10 according to an embodiment of the present disclosure may form the sufficient wedge without increasing the cutting force, so that the skin contact area may be increased, thereby minimizing skin irritation during shaving.

An angle θ₁ formed by the pair of first coating lines 204 may be from 60 to 90 degrees.

Therefore, the razor blade 10 according to an embodiment of the present disclosure may have a pair of first coating facets 202 that extend relatively sharply in the tip region of the coating layer 200. Further, as the thickness of the razor blade 10 near the tip region is reduced, the cutting force is reduced, so shaving performance may be improved. When the angle θ′₁ formed by a pair of first coating lines 204′ exceeds 90 degrees, as in the razor blade 1 according to the prior art of FIG. 2, the thickness near the tip region rapidly increases, which may have a negative effect on the cutting performance.

Since the razor blade 10 according to an embodiment of the present disclosure has a relatively large vertical distance H between the straight line connecting the pair of wedge points 240 and the coating tip 205 while the pair of first coating facets 202 extend relatively sharply, the coating layer 200 may be sufficiently formed near the substrate tip 105, thereby satisfying both excellent durability and low cutting force of the razor blade.

Meanwhile, a distance W between the pair of wedge points 240 may be equal to or greater than the extension length of each of the pair of first coating facets 202.

Further, the radius of curvature formed at the coating tip 205 may be from 50 to 500 Å (angstrom), for example, from 100 to 250 Å.

An angle θ₂ formed by a pair of substrate lines 104 extending in a direction parallel to the linearly extending region of each of the pair of substrate facets 102 may be from 15 to 30 degrees.

From a region that is a certain distance away from the substrate tip 105, the region becomes farther away from the tip region of the razor blade 10, the substrate 100 becomes thicker, and the ratio of the thickness of the substrate 100 to the total thickness of the razor blade 10 may increase. When the razor blade 10 involved in the initial cutting of the hair is moved beyond a certain region, the shape of the substrate 100 has a greater influence on the performance of the razor blade 10 than the shape of the coating layer 200, so it is unnecessary to increase the thickness of the coating layer 200 after a certain region.

When the reference line 150 is used as a horizontal axis, the average gradient of the pair of first coating facets 202 may be greater than the average gradient of the pair of second coating facets 206. Further, an angle θ₃ formed when each of the pair of first coating lines 204 and each of the pair of second coating lines 208 intersect with each other may be from 18 to 25 degrees. This prevents the coating layer 200 from becoming unnecessarily thick in the region after the pair of wedge points 240.

Further, a straight line tangent to the coating layer 200 at the point CD₁ may be substantially parallel to a straight line tangent to the substrate 100 at the point SD₁. That is, at the points SD₁ and CD₁, the substrate 100 and the coating layer 200 may extend substantially parallel to each other. Since the coating layer 200 has a uniform thickness from the points SD₁ and CD₁, the substrate 100 and the coating layer 200 may be substantially parallel.

Meanwhile, the point where the distance measured in the direction perpendicular to the reference line 150 from the point SDx to the reference line 150 and the thickness CTx of the coating layer 200 at the point SDx are substantially equal may be one or more points in the range of SD₁ to SD₄. That is, the point where the sum of the thicknesses of the coating layers 200 disposed on both sides of the substrate 100 in FIG. 1 becomes equal to the thickness of the substrate 100 measured in a direction parallel to the horizontal line 250 may be located within the range of SD₁ to SD₄ on the substrate 100.

In the razor blade 10 according to an embodiment of the present disclosure, a point where the sum of the thicknesses of the coating layers 200 disposed on both sides of the substrate 100 becomes equal to the thickness of the substrate 100 measured in a direction parallel to the horizontal line 250 is relatively far from the coating tip 205. Therefore, the distance between the coating tip 205 and the substrate tip 105 may be relatively increased, thereby more effectively protecting the substrate tip 105.

Examples that may include the aforementioned technical features include the following numerical ranges for the thicknesses of the substrate 100 and the thickness of the coating layer 200. Here, the thickness of the coating layer 200 is the sum of the thicknesses of the coating layers 200 disposed on both sides of the substrate 100. However, the substrate 100 is not present in a region that is 0.5 micrometers away from the coating tip 205. The thickness of the coating layer 200 in the region where the substrate 100 does not exist means the thickness measured in a direction parallel to the horizontal line 250 between a pair of first coating facets 202 or between a pair of second coating facets 206.

TABLE 1

| | | | | | Ration of | | Ration of | |
|---|---|---|---|---|---|---|---|---|
| | Coating layer | | | | Substrate | | Coating layer | |
| Distance | thickness (Sum of | | Substrate | | thickness to | | thickness to/ | |
| from | both sides) | | thickness | | Coating layer | | Substrate | |
| coating | (μm) | | (μm) | | thickness | | thickness | |
| tip (μm) | min | max | min | max | min | max | min | max |
| 0.5 | 0.6318 | 0.7722 | — | — | — | — | — | — |
| 1 | 0.6759 | 0.8261 | 0.2025 | 0.2475 | 0.27 | 0.33 | 3.0042 | 3.6718 |
| 2 | 0.6615 | 0.8085 | 0.5256 | 0.6424 | 0.7155 | 0.8745 | 1.1322 | 1.3838 |
| 3 | 0.6678 | 0.8162 | 0.7767 | 0.9493 | 1.0467 | 1.2793 | 0.774 | 0.946 |
| 4 | 0.6615 | 0.8085 | 1.0764 | 1.3156 | 1.4643 | 1.7897 | 0.5535 | 0.6765 |
| 5 | 0.6741 | 0.8239 | 1.2204 | 1.4916 | 1.6281 | 1.9899 | 0.4977 | 0.6083 |
| 6 | 0.6597 | 0.8063 | 1.4166 | 1.7314 | 1.9323 | 2.3617 | 0.4194 | 0.5126 |
| 8 | 0.6606 | 0.8074 | 2.0556 | 2.5124 | 2.8008 | 3.4232 | 0.2889 | 0.3531 |

The razor blade 10 according to an embodiment of the present disclosure is configured such that the substrate 100 is relatively thin. For instance, the thickness ST₄ of the substrate 100 measured in a direction perpendicular to the reference line 150 at a point that is 4 micrometers away from the substrate tip 105 along the reference line 150 may be from 1 to 1.6 micrometers, and the thickness ST₈ of the substrate 100 measured in a direction perpendicular to the reference line 150 at a point that is 8 micrometers away from the substrate tip 105 along the reference line 150 may be from 1.9 to 2.72 micrometers. A value obtained by dividing ST₄ by ST₈ may range from 0.368 to 0.842.

Further, examples that may include the aforementioned technical features include the following numerical ranges for the thicknesses of the razor blade 10. Here, the thickness of the razor blade 10 is measured in a direction perpendicular to the reference line 150 at a point that is spaced apart from the coating tip 205 along the reference line 150.

TABLE 2

| | Thickness of razor blade (μm) | |
|---|---|---|
| Distance from coating tip (μm) | min | max |
| 0.05 | 0.08 | 0.099 |
| 0.1 | 0.135 | 0.191 |
| 0.2 | 0.252 | 0.343 |
| 0.25 | 0.306 | 0.42 |
| 0.3 | 0.35 | 0.478 |
| 0.4 | 0.418 | 0.620 |
| 0.5 | 0.475 | 0.716 |
| 0.6 | 0.512 | 0.814 |
| 0.8 | 0.562 | 0.936 |
| 1 | 0.65 | 1.3 |
| 2 | 0.95 | 1.67 |

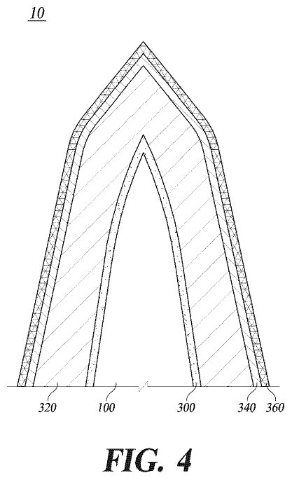

FIG. 4 is a detailed view showing the coating layer 200 of the razor blade 10 according to an embodiment of the present disclosure.

The coating layer 200 may include a first coating layer 320 and a second coating layer 360.

The first coating layer 320 is a layer laminated on the substrate 100, and may include at least one of CrₓC_{y}B_{z} (x, y, and z are natural numbers equal to or greater than 1), CrₘBₙ (m and n are natural numbers equal to or greater than 1), CrC, and DLC (Diamond-Like Carbon). For instance, CrₘBₙ may include CrB (m=n=1), CrB₂ (m=1, n=2), CrB₄ (m=1, n=4), Cr₂B (m=2, n=1), etc.

Thus, the overall strength of the razor blade 10 may be increased and the razor blade may have corrosion resistance. Further, materials such as CrₓC_{y}B_{z} (x, y, and z are natural numbers equal to or greater than 1) and CrₘBₙ (m and n are natural numbers equal to greater than 1) have high rigidity, so that the durability of the razor blade 10 may be sufficiently secured even when the substrate 100 is thin.

In FIG. 4, an adhesive layer 300 for improving adhesion is disposed between the first coating layer 320 and the substrate 100. The adhesive layer 300 may include Cr or Nb, but the adhesive layer 300 may be omitted.

The second coating layer 360 is a layer laminated on the first coating layer 320, and may include a PTFE component. Thus, the second coating layer 360 may reduce a frictional force between the razor blade 10 and the skin.

In FIG. 4, an intermediate layer 340 for improving adhesion is disposed between the second coating layer 360 and the first coating layer 320. The intermediate layer 340 may include Cr or Nb, but the intermediate layer 340 may be omitted.

The spirit of the present embodiment is illustratively described hereinabove. It will be appreciated by those skilled in the art to which the present embodiment pertains that various modifications and alterations may be made without departing from the essential characteristics of the present embodiment. Accordingly, the present embodiments are not to limit the spirit of the present embodiment, but are to describe the spirit of the present embodiment. The technical idea of the present embodiment is not limited to these embodiments. The scope of the present embodiment should be interpreted by the following claims, and it should be interpreted that all the spirits equivalent to the following claims fall within the scope of the present embodiment.

What is claimed is:

1. A razor blade comprising:
a substrate; and
a coating layer formed on the substrate and comprising a coating tip formed on an end portion thereof,
wherein:
the coating layer comprises a pair of coating facets extending from the coating tip,
the pair of coating facets comprise:
a pair of first coating facets each comprising a first end forming the coating tip; and
a pair of second coating facets each connected to a second opposing end of each of the pair of first coating facets,
when a pair of points where the pair of first coating lines extending in directions parallel to linearly extending regions of the pair of first coating facets and the pair of second coating lines extending in directions parallel to linearly extending regions of the pair of second coating facets intersect with each other are referred to as a pair of virtual points,
a pair of points where a plurality of straight lines perpendicular to the pair of first coating lines from the pair of virtual points intersect with the pair of coating facets are referred to as a pair of wedge points, and
a vertical distance between a straight line connecting the pair of wedge points and the coating tip ranges from 0.5 to 1.5 micrometers.

2. The razor blade of claim 1, wherein a distance between the pair of wedge points ranges from 0.7 micrometers to 1.2 micrometers.

3. The razor blade of claim 1, wherein:
the substrate has a substrate tip formed on an end portion, and
a distance between the substrate tip and the coating tip ranges from 0.15 micrometers to 1.2 micrometers.

4. The razor blade of claim 1, wherein an angle formed by a pair of first coating facets at the coating tip ranges from 60 degrees to 90 degrees.

5. The razor blade of claim 1, wherein:
the substrate comprises a substrate tip formed on an end portion, and
when a reference line passing through both the coating tip and the substrate tip is set as a horizontal axis, an average gradient of the pair of first coating facets is greater than an average gradient of the pair of second coating facets.

6. The razor blade of claim 5, wherein:
the substrate comprises a pair of substrate facets extending from the substrate tip,
a point where a horizontal line that is perpendicular to the reference line and passes through a point x micrometers away from the substrate tip along the reference line intersects with any one of the pair of substrate facets is defined as SDx,
a thickness of the coating layer at the point SDx is defined as a thickness measured in a direction perpendicular to a straight line tangent to the substrate at the point SDx, and
a point where a distance measured in a direction perpendicular to the reference line from the point SDx to the reference line becomes equal to the thickness of the coating layer at the point SDx is one or more points in a range of SD₁ to SD₄.

7. The razor blade of claim 5, wherein an angle formed by each of the pair of the first coating lines and each of the pair of the second coating lines ranges from 18 degrees to 25 degrees.

8. The razor blade of claim 1, wherein:
the substrate comprises a substrate tip formed on an end portion thereof, and
a straight line passing through the coating tip and the substrate tip is defined as a reference line, and
a thickness of the razor blade, measured in a direction perpendicular to the reference line at a point 0.05 micrometers away from the coating tip along the reference line, ranges from 0.08 micrometers to 0.099 micrometers.

9. The razor blade of claim 1, wherein:
the substrate comprises a substrate tip formed on an end portion thereof,
a straight line passing through the coating tip and the substrate tip is defined as a reference line, and
a thickness of the razor blade, measured in a direction perpendicular to the reference line at a point 0.5 micrometers away from the coating tip along the reference line, ranges from 0.475 micrometers to 0.716 micrometers.

10. The razor blade of claim 1, wherein:
the substrate comprises a substrate tip formed on an end portion thereof,
a straight line passing through the coating tip and the substrate tip is defined as a reference line, and
a thickness of the razor blade, measured in a direction perpendicular to the reference line at a point 1 micrometers away from the coating tip along the reference line, ranges from 0.65 micrometers to 1.3 micrometers.

11. The razor blade of claim 1, wherein:
the substrate comprises a substrate tip formed on an end portion thereof,
a straight line passing through the coating tip and the substrate tip is defined as a reference line, and
a thickness of the razor blade, measured in a direction perpendicular to the reference line at a point 2 micrometers away from the coating tip along the reference line, ranges from 0.95 micrometers to 1.67 micrometers.

12. The razor blade of claim 1, wherein:
the substrate comprises a substrate tip formed on an end portion thereof,
a straight line passing through the coating tip and the substrate tip is defined as a reference line, and
a thickness of the substrate, measured in a direction perpendicular to the reference line at a point 4 micrometers away from the substrate tip along the reference line, ranges from 1 micrometers to 1.6 micrometers.

13. The razor blade of claim 1, wherein:
the substrate comprises a pair of substrate facets extending from the substrate tip, and
an angle formed by a pair of substrate lines extending in directions parallel to linearly extending regions of the pair of substrate facets ranges from 15 degrees to 30 degrees.

14. The razor blade of claim 1, wherein the coating layer comprises at least one of CrₓC_{y}B_{z} (x, y, and z are natural numbers equal to or greater than 1), CrₘBₙ (m and n are natural numbers equal to or greater than 1), CrC, or diamond-like carbon (DLC).
